(19) United States
(12) Patent Application Publication
(10) Pub. No.: US 2026/0192786 A1
(43) Pub. Date: Jul. 9, 2026

(54) SAFETY SYSTEM FOR A VEHICLE

(71) Applicant: International Truck Intellectual Property Company, LLC, Lisle, IL (US)

(72) Inventor: Kevin Elskafoss, Naperville, IL (US)

(73) Assignee: International Truck Intellectual Property Company, LLC, Lisle, IL (US)

(21) Appl. No.: 19/132,406

(22) PCT Filed: Jan. 10, 2023
(86) PCT No.: PCT/US2023/010465

§ 371 Date: May 23, 2025

(51) Int. Cl. B60T 7/22; B60T 7/02; B60T 8/171; B60T 8/172; B60T 8/174

(52) U.S. Cl. CPC B60T 7/22; B60T 7/02; B60T 8/171; B60T 8/172; B60T 8/174; B60T 2201/022; B60T 2201/03; B60T 2210/32; B60T 2220/00

(57) ABSTRACT

A safety system (110, 210, 310) for a vehicle (102) and a method for controlling a brake system on the vehicle using the safety system are provided. The safety system includes a monitoring system (212) comprising at least one imaging module (224a, 324a) disposed on the vehicle to acquire imaging of an area exterior of the vehicle, and a controller (214) operatively connected to the monitoring system and to a brake control module (116) that operates a brake system on the vehicle, wherein the controller analyzes imaging received from the monitoring system to identify at least one targets in the area exterior of the vehicle, and provides a control signal to the brake control module when the at least one targets are determined to be at risk. The safety system also includes an interlock system (216) operatively connected to the controller, and provides an override signal to the controller when activated by an operator.

### FIELD

The present disclosure generally relates to vehicle components and operations. More particularly, embodiments described relate to a safety system for a vehicle.

### BACKGROUND

Various vehicle technologies have been developed to protect the public. While some vehicle systems have improved pedestrian safety near moving vehicles, a number of vehicle systems have shortcomings. For instance, some vehicle systems may only provide video monitoring of blind spots, but not the entire area surrounding the vehicle. Also, some vehicle systems may only alert drivers that pedestrians are near the vehicle, but do not provide a video feed that displays the exact location of the pedestrians. Additionally, while some vehicle systems inform a driver of the presence of pedestrians, these vehicle systems leave it up to the driver to take action and avoid collision with the pedestrians. Should a driver be distracted or fail to take action, injury or damage may follow. Furthermore, some vehicle systems may be capable of automatic braking, but may only brake for objects and pedestrians that are in front of the vehicle. That is, such vehicle systems may not be able to detect or respond to objects or pedestrians that are on the sides or behind the vehicle.

Therefore, there is a need for improving vehicle safety to prevent collisions with pedestrians and objects that are near a vehicle.

### SUMMARY

A safety system for a vehicle and a method for controlling a brake system on the vehicle using the safety system are provided.

In one embodiment, a safety system for a vehicle is provided. The safety system includes a monitoring system comprising at least one imaging module disposed on the vehicle to acquire imaging of an area exterior of the vehicle, and a controller operatively connected to the monitoring system and to a brake control module that operates a brake system on the vehicle, wherein the controller analyzes imaging received from the monitoring system to identify at least one targets in the area exterior of the vehicle, and provides a control signal to the brake control module when the at least one targets are determined to be at risk. The safety system also includes an interlock system operatively connected to the controller, and provides an override signal to the controller when activated by an operator.

In another embodiment, the method for controlling a brake system on a vehicle using a safety system is provided. The method includes receiving imaging of an area exterior to a vehicle acquired using a monitoring system, using a controller disposed on the vehicle, analyzing imaging acquired by the monitoring system to identify at least one targets in the area exterior to the vehicle. The method also includes providing, using the controller, a control signal to a brake control module to control a brake system on the vehicle when the at least one targets are determined to be at risk, and providing an override signal to the controller when an interlock system on the vehicle is activated by an operator. The method further includes interrupting the control signal when the controller receives the override signal from the interlock system.

### BRIEF DESCRIPTION OF THE DRAWINGS

FIG. 1 is a diagram showing an example system, as described herein;

FIG. 2 is a diagram showing an example safety system, as described herein;

FIG. 3A is an illustration of a vehicle with an example safety system, as described herein;

FIG. 3B is an illustration depicting a safety region around an exterior of a vehicle, as described herein;

FIG. 3C is an illustration depicting a variation of the safety region shown in FIG. 3B;

FIG. 3D is an illustration depicting another variation of the safety region shown in FIG. 3B;

FIG. 3E is an illustration depicting a mode of operation of a safety system, as described herein;

FIG. 4 is a flowchart setting forth steps of a process, as described herein;

FIG. 5A is an example report or notification provided to an operator, as described herein; and

FIG. 5B is another example report or notification provided to an operator, as described herein.

### DETAILED DESCRIPTION

Safety is a major concern when operating a vehicle, particularly when the vehicle is large or when the vehicle is operating in a busy or risk-prone environment. For example, a city or school bus presents considerable risks to pedestrians, and especially when the pedestrians are children. Thus, embodiments described herein provide a safety system and method for controlling a brake system on the vehicle using the safety system, which, among many improvements provided, enhances vehicle safety.

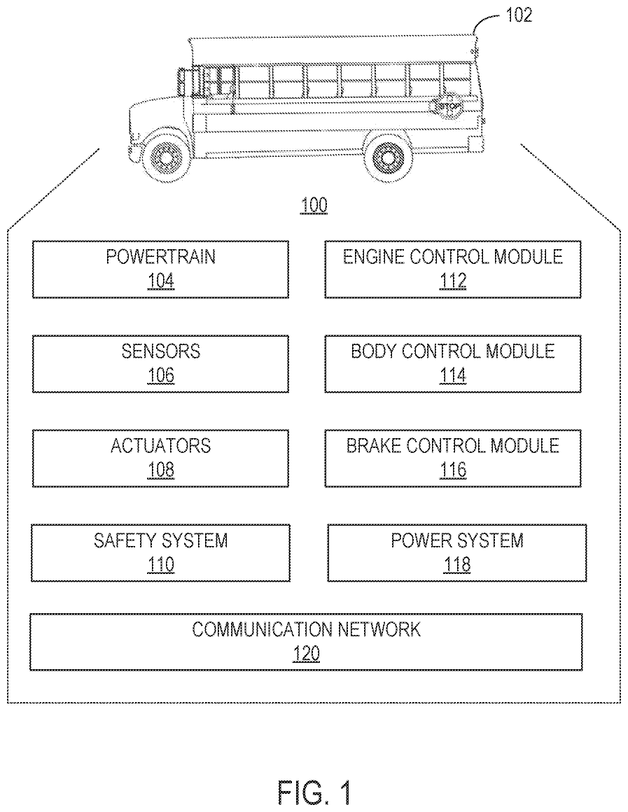

FIG. 1 illustrates an example system 100 in accordance with aspects of the present disclosure. The system 100 may be part of or incorporated into a vehicle 102. The vehicle 102 may include various types of automobiles, buses, trucks, trailer tractors, utility vehicles, sport utility vehicles (SUVs), recreational vehicles (RVs), construction vehicles, highway vehicles, and so forth, as well as various types of boats, planes, drones, trains, and so forth. In some embodiments, the vehicle 102 is a school bus. In some embodiments, as shown in FIG. 1, the system 100 may include a powertrain 104, sensors 106, actuators 108, and a safety system 110, at least one of which is disposed on the vehicle 102.

As shown in FIG. 1, the powertrain 104 may include a variety of components, including an engine, transmission, driveshaft, axle, differential and so forth, that together create power to propel the vehicle 102. In some applications, the vehicle 102 is powered by an internal combustion engine, an internal compression engine, an electric engine, a fusion engine and the like. In other applications, the vehicle 102 is powered by electric power provided by at least one electric motors. In yet other applications, the vehicle 102 is powered by a combination of electric and combustion power.

The sensors 106 of the system 100 may include a variety of sensors and sensing devices that may detect information about vehicle 102 and environment in which the vehicle 102 operates. The sensors 106 may include current sensors, voltage sensors, mass sensors, fuel sensors, temperature sensors, flow sensors, gas sensors, coolant sensors, sparkplug sensors, coolant sensors, throttle sensors, speed sensors, cameras, and the like. In some embodiments, the sensors 106 may capture data about the vehicle 102 and/or the vehicle 102 environment and send data to various the vehicle 102 components, including the powertrain 104, actuators 108, safety system 110, engine control module (ECM) 112, body control module (BCM) 114, brake control module 116, power system 118, and so forth, as described in more detail herein.

The actuators 108 of the system 100 may perform a multitude of tasks including regulating fluid flow, moving components, controlling valves, activating switches, operating gears, and so forth on the vehicle 102. The actuators 108 may operate by hydraulic, pneumatic, magnetic, mechanical, thermal or electrical activation or movement of components. In some embodiments, at least one actuators 108 may be used to operate a safety system 110 on the vehicle 102. For example, if the vehicle 102 is a school bus, the actuators 108 may deploy a stop arm, a crossing arm, or a sign that instructs surrounding drivers to stop.

The safety system 110 may include a number of components and component assemblies that together operate to enhance safety of the vehicle 102, as described in more detail herein. In some embodiments, the safety system 110, and/or components therein, may acquire imaging of an area around or exterior to a vehicle, and process imaging to identify at least one targets that are present in area exterior to the vehicle 102. As described herein, targets need not to be previously identified or tracked, but may be certain targets generally known to be at risk from, or pose a risk to, vehicles (e.g., persons, animals, objects, and so forth). When at least one targets are determined to be at risk or pose a risk, the safety system 110 may then generate and provide a control signal to the brake control module 116 to engage the brake system (not shown) on the vehicle 102. In this manner, the vehicle 102 may be prevented automatically from moving and causing injury or damage. In some embodiments, an override on the safety system 110 may be activated by an operator (e.g., a driver of the vehicle 102) to interrupt or modify the control signal provided to the brake control module 116. The brake system may then be disengaged if persons, animals or objects are not deemed by the operator to represent a risk. For example, certain targets may be erroneously identified by the safety system 110 as posing a risk, or being at risk, but which, in fact, do not represent a risk (e.g. a mannequin, decoration, statue, or the like).

The ECM 112 may monitor and control various parameter and functions of the engine of vehicle 102, including the air-fuel ratio, idle speed, valve timing, ignition timing, crankshaft position, and so forth. To perform such functions, the ECM 112 may include any combination of analog and/or digital inputs and outputs, microprocessors, integrated circuitry, memories, clocks, Application Programming Interfaces (APIs), firmware, software, and so forth, and may communicate with various components on the vehicle 102. For example, in some implementations, the ECM 112 may communicate with sensors 106, components the vehicle 102, such as an exhaust system, and so forth.

The BCM 114 may monitor and control various vehicle body, security, and convenience functions of the vehicle 102. For instance, the BCM 114 may manage exterior lighting, interior lighting, vehicle 102 locking, door and/or trunk opening and/or closing, remote entry, remote start, windshield wipers, seat adjustment, tire pressure monitoring, and so forth. To perform such functions, the BCM 114 may include any combination of analog and/or digital inputs and outputs, microprocessors, integrated circuitry, programmable circuitry, clocks, APIs, and so forth, and may communicate with, monitor, and control various sensors 106, actuators 108, and other components disposed on the vehicle 102.

The brake control module 116 may operate a brake system (not shown) on the vehicle 102. The brake control module 116 may include or communicate with a variety of other elements, components, and hardware on the vehicle 102. The brake control module 116 can operate independently, but may also cooperate with various external computers, systems, devices and hardware. In some embodiments, the brake control module 116 may communicate with the safety system 110 and coordinate operation of the brake system of the vehicle 102 using control signals provided by the safety system 110. To this end, the brake control module 116 may include specific hardware and/or control logic responsive to control signals provided by the safety system 110.

Although specific examples of control modules are shown in FIG. 1 as being included in the system 100, the system 100 may include more or fewer control modules, and may integrate or separate different or other functionalities for monitoring and/or controlling of components on the vehicle 102. For instance, although FIG. 1 shows the ECM 112 and BCM 114 as separate components, in some embodiments, the ECM 112 and BCM 114 may be carried out by a single control module. In some embodiments, the system 100 may include additional modules for climate control, transmission control, traction control, and so on. In other embodiments, the system 100 may include a powertrain control module that monitors and/or control the ignition system, fuel injection, emission systems, mechanical positioning of the rotating assembly, exhaust system, transmission, and any other functions related to the operation of the engine and transmission.

Referring again to FIG. 1, the power system 118 may provide electrical power to various components of the vehicle 102. For example, the power system 118 may power the sensors 106, the actuators 108, the safety system 110, the ECM 112, the BCM 114, the brake control module 116, as well as other components disposed on the vehicle 102. To generate and deliver power, the power system 118 may include a variety of hardware and components, including at least one batteries, solar panels, starters, alternators, relays, converters, controllers, regulators, switches, solenoids, electrical wiring, electrical circuitry, electrical elements, and so forth.

Components of the system 100 may be connected to one another, and exchange signals, data, and information, by way of a communication network 120, as shown in FIG. 1. The communication network 120 may include a variety of hardware and components that provide wired and/or wireless connectivity. In some embodiments, the communication network 120 may include at least one communication buses that interconnect components and hardware in the system 100, and implement at least one communications protocols. Non-limiting example communication protocols include Control Area Network (CAN), Local Interconnect Network (LIN), Flex-Ray, Vehicle Area Network (VAN), Media Oriented System Transport (MOST), Ethernet, and so forth. The communications network 120 may also include various gateways, bridges, receivers, transmitters, transceivers, modems, routers, and other components, devices, and hardware facilitating communication. In some embodiments, the communication network 120 may also provide connectivity to systems and devices that are external to the system 100, such as a remote server, a cloud, and so forth.

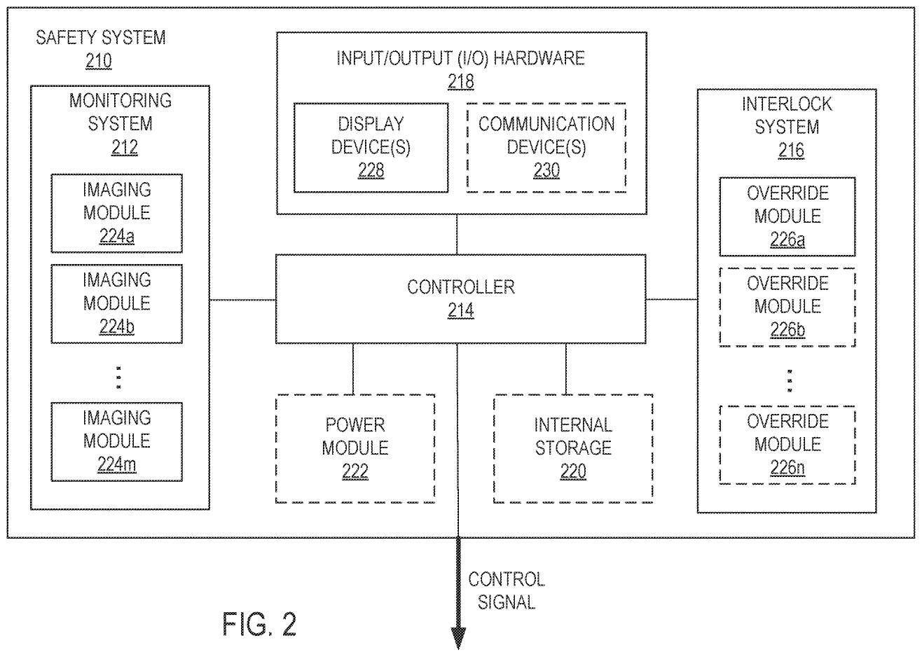

Referring now to FIG. 2, a schematic diagram of a safety system 210 that may enhance the safety of a vehicle 102 is shown. In some embodiments, the safety system 210 may include a monitoring system 212, a controller 214, an interlock system 216, and various input/output (I/O) hardware 218 components, as shown in FIG. 2. The safety system 210 may optionally include at least one additional components, such as an internal storage 220 and/or power module 222, as shown in FIG. 2.

The monitoring system 212 may monitor an area around or exterior to a vehicle 102, i.e., a monitored area, as well as an interior of the vehicle 102, at least one occupant and/or operator of the vehicle 102, and so forth. In some embodiments, the monitoring system 212 may include a number of imaging module 224a, 224b, 224c, 224d, 224e, 224f, 224g, 224h, 224l, 224j, 224k, 224l and 224m that are disposed around the vehicle 102. The number of imaging module 224a, 224b, 224c, 224d, 224e, 224f, 224g, 224h, 224l, 224j, 224k, 2241 and 224m is not limited. In some embodiments, at least one of the imaging module 224a, 224b, 224c, 224d, 224e, 224f, 224g, 224h, 224l, 224j, 224k, 224l and 224m may include at least one camera (not shown in FIG. 2) that can capture, record, store, and transmit images or video. For example, the camera(s) may include a digital single-lens reflex camera, a mirrorless camera, a bridge camera, a panoramic/360-degree camera, twin-lens reflex camera, or any combination thereof. In some embodiments, the camera(s) may have an extreme wide-angle lens, a wide-angle lens, a normal zoom lens, a telephoto zoom lens, a telephoto lens, and so forth, as well as lenses or capabilities that allow for depth perception. In some embodiments, at least one of the imaging module 224a, 224b, 224c, 224d, 224e, 224f, 224g, 224h, 224i, 224j, 224k, 2241 and 224m of the monitoring system 212 may also include at least one module sensor (not shown in FIG. 2) that can aid in imaging, as well as provide depth or distance information. For example, the module sensor(s) may include light detection and ranging (LiDAR) sensors, radar sensors, proximity sensors, audio sensors or receivers, and so forth.

The monitoring system 212 may include additional components and hardware. For example, in some embodiments, the monitoring system 212 may include various fastening equipment (e.g., fasteners, harnesses, holders, and so forth) that can secure the camera(s), module sensor(s), and/or imaging module 224a, 224b, 224c, 224d, 224e, 224f, 224g, 224h, 224i, 224j, 224k, 224l and 224m, as well as other components and hardware, to the interior and/or vehicle 102. The monitoring system 212 may also include various protective equipment (e.g., housings, protective shields, coatings, coverings, and so forth) for protecting the camera(s), module sensor(s), and/or imaging module 224a, 224b, 224c, 224d, 224e, 224f, 224g, 224h, 224i, 224j, 224k, 224l and 224m from the environment. The monitoring system 212 may further include various communication equipment (e.g., wiring, cables, electrical elements, circuitry, and so forth) that can facilitate transmission of analog or digital signals and data captured by the camera(s) and/or module sensor(s).

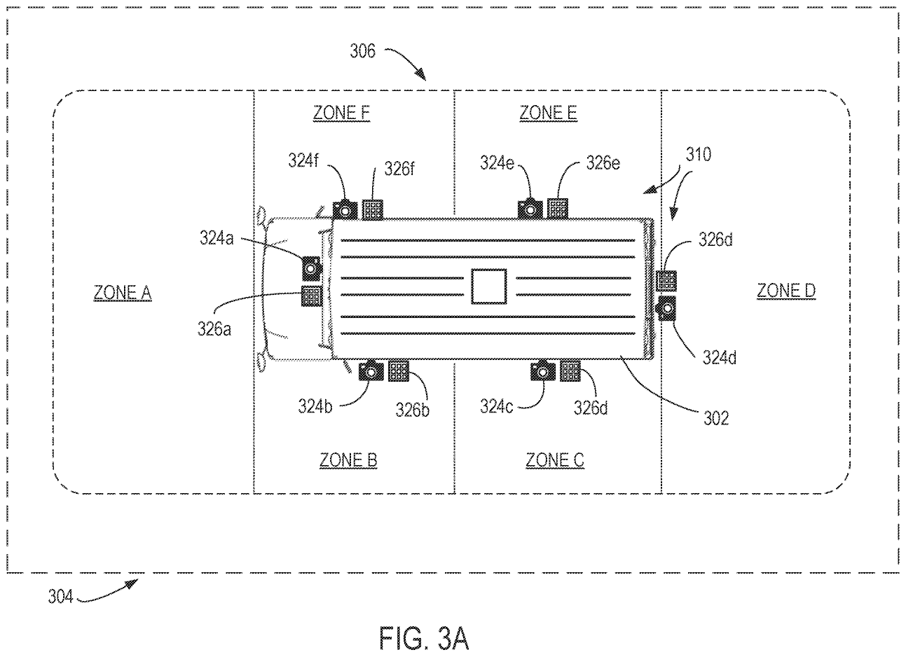

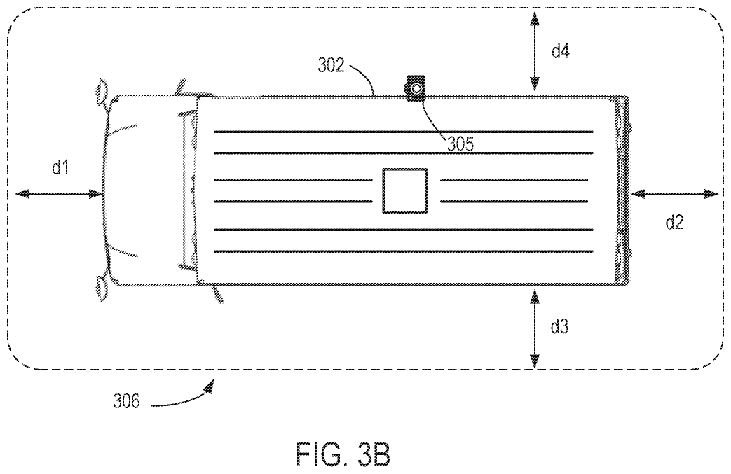

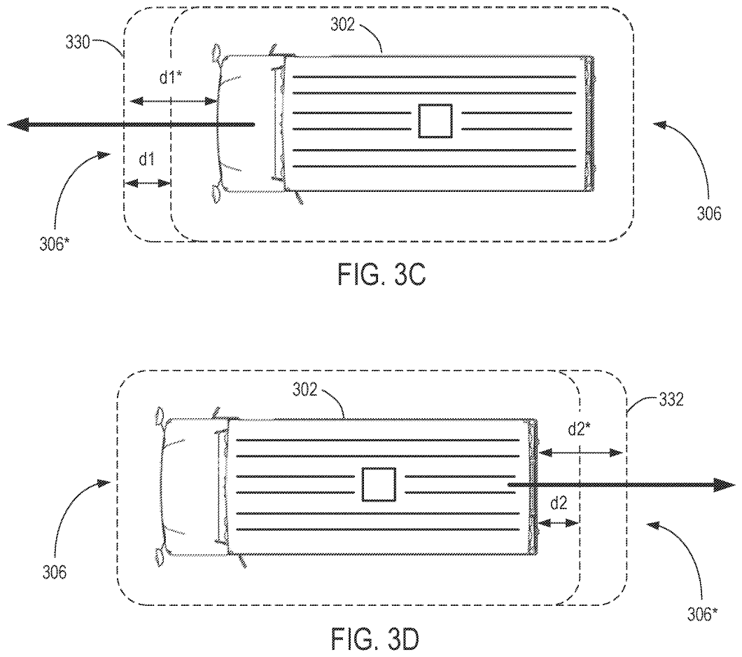

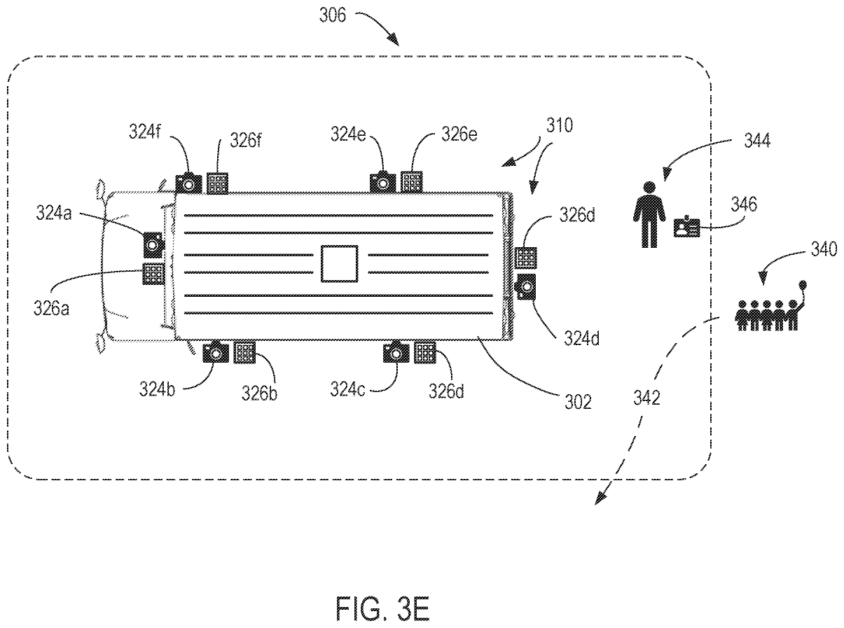

In some embodiments, such as the embodiment illustrated in FIG. 3B, the monitoring system 212 may comprise an element 305, such as a droid and the like, operatively associated with a vehicle 302. The element 305 may be tethered, either wired or wirelessly, to the vehicle 302. The element 305 may move independently of the vehicle 302. The element 305 may include a rotor enabling the element to move in three dimensions. Movement of the element 305 may be controlled by an operator of the vehicle 302 or remotely. The element 305 includes an imaging module substantially similar to the imaging modules 324a, 324b, 324c, 324d, 324e, and 324f. Movement of the element 305 allows the imaging module to image entirety of the risk region 306 and beyond.

The controller 214 may perform a variety of functions for the safety system 210, including functions to operate, monitor, and communicate with the various modules of the safety system 210, as discussed in more detail herein. To carry out functions, the controller 214 may include various types of hardware, including a CPU, a GPU, a microcontroller, and the like, which may be programmed to execute code or machine-readable instructions. In some embodiments, the code or machine-readable instructions may be stored in a non-transitory computer-readable storage medium. The controller 214 may communicate with the various modules of the safety system 210 using analog signals, digital signals, or a combination thereof.

In some implementations, the controller 214 may communicate with and operate the camera(s) and/or module sensor(s) of the imaging module 224a, 224b, 224c, 224d, 224e, 224f, 224g, 224h, 224l, 224j, 224k, 224l and 224m to autonomously or semi-autonomously acquire imaging (e.g., images, video, and so forth) of, as well as other information associated with, an area around or exterior to a vehicle 102, as discussed with reference to FIG. 1. To do so, the controller 214 may control or activate at least one camera(s) and/or module sensor(s) of the imaging module 224a, 224b, 224c, 224d, 224e, 224f, 224g, 224h, 224i, 224j, 224k, 224l and 224m, either continuously or intermittently. For instance, the controller 214 may control camera parameter or setting, like flash, lens, shutter speed, capture or readout rate, focus, magnification, aperture, ISO, and so forth. The controller 214 may also control parameter or setting on the module sensor(s), like wavelength, waveform amplitude or intensity, point density, pulse model, coherent detection, capture or readout rate, and so forth. In some embodiments, the controller 214 may control the imaging module 224a, 224b, 224c, 224d, 224e, 224f, 224g, 224h, 224i, 224j, 224k, 224l and 224m to select or change the area exterior to the vehicle 102 being monitored. The controller 214 may also control the storage of imaging, and other information and data, obtained by the imaging module 224a, 224b, 224c, 224d, 224e, 224f, 224g, 224h, 224i, 224j, 224k, 224l and 224m, as discussed in more detail herein.

The controller 214 may include or carry out at least one routine or instruction for processing output from various modules or elements of the safety system 210. For instance, in some embodiments, the controller 214 may receive and analyze imaging acquired and provided by the imaging module 224a, 224b, 224c, 224d, 224e, 224f, 224g, 224h, 224i, 224j, 224k, 224l and 224m. For example, the controller 214 may analyze imaging to identify at least one target (e.g., persons, animals, objects and so forth) present in the area around or exterior to the vehicle 102. To do so, the controller 214 may use various computer vision or machine learning algorithms trained to detect the target(s). For instance, in one non-limiting example, the controller 214 may utilize face recognition software to detect faces of persons appearing in the imaging. In another non-limiting example, the controller 214 may utilize a machine learning model that is trained to detect persons appearing in the imaging. In yet another non-limiting example, the controller 214 may utilize a machine learning model that is trained to establish identity of a person. In some embodiments where the vehicle 102 is a school bus and the at least one target is a student, the controller 214 may interface with a school safety and dismissal platform, such as Pikmykid of Tampa. Florida and the like, thereby enabling monitoring of student.

In some embodiments, a quality or accuracy of the computer vision or machine learning algorithm(s) used by the controller 214 may be improved or updated. For instance, imaging acquired by the monitoring system 212, along with indications of targets detected in the video by the controller 214, may be transmitted to a remote location (e.g. a server, a cloud, a data collection center, a data processing center, an original equipment manufacturer, and so forth). In addition, feedback provided by an operator, reflecting a quality or accuracy of the computer vision or machine learning algorithm(s), along with other data and information (e.g. time, date, location, weather condition, and so forth), may also be transmitted to the remote location. For example, in some embodiments, such feedback may be in the form of overrides, as described in more detail below. The remote location may then analyze imaging, target detections, operator feedback and so forth, to assess and/or improve the quality or accuracy of the algorithm(s). The remote location may then update the algorithm(s), for example, by pushing software or firmware updates to the controller 214.

In some embodiments, the controller 214 may pre-process imaging and/or sensor data acquired by camera(s) and/or sensor module(s) of the imaging module 224a, 224b, 224c, 224d, 224e, 224f, 224g, 224h, 224i, 224j, 224k, 224l and 224m. For instance, the controller 214 may resize, orient, filter, window, mask, color-correct, aggregate, downsample, transform, and so forth, imaging and/or sensor data. In some embodiments, the controller 214 may also assemble various images using imaging and/or sensor data. For example, the controller 214 may assemble topographical maps or depth maps, point cloud maps, using LiDAR data acquired using a LiDAR sensor, for instance, and thereby provide depth or distance information associated with at least one target identified.

In some embodiments, the controller 214 may determine whether the target(s) identified in imaging are at risk. Alternatively, the controller 214 may determine whether the target(s) identified in imaging pose a risk to the vehicle 102. Either way, the controller 214 may analyze imaging to determine a location of each targets, and/or a distance between each target and a vehicle 102. In some embodiments, the location(s) and/or distance(s) to the target(s) may be determined by analyzing imaging acquired by at least one cameras. To do so, the controller 214 may utilize camera information (e.g., focus, magnification, position, orientation, field of view, etc. . . . ). In other embodiments, the location(s) and/or distance(s) to the target(s) may be determined by the controller 214 from depth information obtained directly from, or by processing, sensor data (e.g., LiDAR data, proximity data, etc.). To do so, the controller 214 may access other information or data, like navigation or global positioning system (GPS) data and information, for instance.

Using location and/or distance(s) to the target(s), the controller 214 may determine whether the target(s) is/are, or will be, inside a risk region around the vehicle 102, and hence whether the target(s) and/or vehicle 102 is/are, or will be, at risk. In some embodiments, the controller 214 may compute a probability of risk to the target(s) and/or vehicle 102. In computing the probability of risk, the controller 214 may utilize various information, like size and/or type of target(s), speed and/or trajectory of target(s) and/or vehicle 102, estimated duration of target(s) inside the risk region, and so forth.

As illustrated in FIG. 2, in some embodiments, the controller 214 may generate and provide a control signal to a brake control module 116, as described with reference to FIG. 1. To generate the control signal, the controller 214 may include, direct, or communicate with, components or hardware capable of generating the control signal. The control signal may be any analog signal, digital signal, or a combination thereof. For example, the control signal may be in the form of a steady-state, periodic, or pulsed DC voltage with positive or negative value(s) ranging between 0.1 and 5 volts, although other waveforms or voltages may be possible. The control signal may be provided by the controller 214 indefinitely, or for a predetermined brake lock time (e.g., 30 seconds, 1 minute, 5 minutes, and so forth). In some embodiments, the control signal may be provided when the controller 214 determines that at least one targets are inside a risk region. In other embodiments, the control signal may be provided when a probability of risk exceeds a predetermined threshold (e.g., 50%, 70%, 90%, and so forth). The controller 214 may also interrupt or modify the control signal provided to the brake control module 116 to disengage the brake system when the controller 214 determines that the target(s) are no longer at risk. For instance, the controller 214 may interrupt or modify the control signal when determining (e.g., from imaging) that the target(s) are outside the risk region, or when the probability of risk falls below the predetermined threshold. Alternatively, the controller 214 may send another control signal to the brake control module 116 to disengage the brake system.

The safety system 210 may also include an interlock system 216 that is operatively connected to the controller 214, as shown in FIG. 2. The interlock system 216 allows an operator to override automatic control of a brake system on a vehicle 102 by providing an override signal to the controller 214 to interrupt or modify the control signal provided by the controller 214. In some embodiments, the interlock system 216 may include a number n of override modules 226a, 226b, 226c, 226d, 226e, 226f, 226g, 226h, 226i, 226j, 226k, 226l and 226m disposed on a vehicle 102. In some embodiments, the override modules 226a, 226b, 226c, 226d, 226e, 226f, 226g, 226h, 226i, 226j, 226k, 226l and 226m may be disposed on the vehicle 102. The number of override modules 226a, 226b, 226c, 226d, 226e, 226f, 226g, 226h, 226i, 226j, 226k, 226l and 226m is not limited. The override modules 226a, 226b, 226c, 226d, 226e, 226f, 226g, 226h, 226i, 226j, 226k, 226l and 226m may include various input components or hardware, like a switch, a button, a keyboard, a touchscreen, a keypad, a near field communication (NFC) tag reader, a radio-frequency identification (RFID) tag reader, and so forth. In some embodiments, the override modules 226a, 226b, 226c, 226d, 226e, 226f, 226g, 226h, 2261, 226j, 226k, 226l and 226m may also include various security features to prevent unauthorized or accidental activation. For example, the override modules 226a, 226b, 226c, 226d, 226e, 226f, 226g, 226h, 226i, 226j, 226k, 226l and 226m may be activated using a key card, a password, a PIN, an RFID tag, and so forth.

The interlock system 216 may include additional components and hardware. For example, in some embodiments, the interlock system 216 may include various fastening equipment (e.g., fasteners, harnesses, holders, and so forth), protective equipment (e.g., housings, protective shields, coatings, coverings, and so forth), various communication equipment (e.g., wiring, cables, electrical elements, circuitry, and so forth), and so forth.

In some embodiments, the number of imaging module 224a, 224b, 224c, 224d, 224e, 224f, 224g, 224h, 224i, 224j, 224k, 224l and 224m may correspond to a number of override modules 226a, 226b, 226c, 226d, 226e, 226f, 226g, 226h, 226i, 226j, 226k, 2261 and 226m. That is, for each imaging module 224a, 224b, 224c, 224d, 224e, 224f, 224g, 224h, 224l, 224j, 224k, 224l and 224m in the monitoring system 212 there is a corresponding override module 226a, 226b, 226c, 226d, 226e, 226f, 226g, 226h, 226i, 226j, 226k, 226l and 226m in the interlock system 216. In addition, in some embodiments, corresponding imaging modules 224a, 224b, 224c, 224d, 224e, 224f, 224g, 224h, 224i, 224j, 224k, 224l and 224m and override modules 226a, 226b, 226c, 226d, 226e, 226f, 226g, 226h, 226i, 226j, 226k, 226l and 226m may be located adjacent or positioned in close proximity (e.g. less than 10 cm, 20 cm, 30 cm, etc.) to each other on the vehicle 102, as discussed in more detail herein. This arrangement may facilitate an operator of the vehicle 102 to verify that an imaging module 224a, 224b, 224c, 224d, 224e, 224f, 224g, 224h, 224i, 224j, 224k, 224l and 224m has correctly identified at least one target. For example, in some embodiments, an imaging module and an override module may be included in a single housing or casing.

An operator may activate any one of the override modules 226a, 226b, 226c, 226d, 226e, 226f, 226g, 226h, 226i, 226j, 226k, 226l and 226m by providing input thereto. In some cases, activation of any one of the override modules 226a, 226b, 226c, 226d, 226e, 226f, 226g, 226h, 2261, 226j, 226k, 226l and 226m may include satisfying any security requirement (e.g., scanning a card or badge, imaging an operator, inputting a password, etc.). In response to activation, the activated override module 226a, 226b, 226c, 226d, 226e, 226f, 226g, 226h, 226i, 226j, 226k, 226l and 226m may then generate and provide an override signal to the controller 214. The override signal may be any analog signal, digital signal, or a combination thereof. For example, the override signal may be in the form of a steady-state, periodic, or pulsed dc voltage with positive or negative value(s) ranging between 0.1 and 5 volts, although other waveforms or voltages may be possible. Upon receiving the override signal, the controller 214 may interrupt or modify the control signal provided to the brake control module 116, or alternatively send another control signal to the brake control module 116 to disengage the brake system once again. In this manner, the interlock system 216 allows for releasing brakes on the vehicle 102 once an operator ensures that there is no risk.

The controller 214, after receiving the override signal from the interlock system 216, may, in some embodiments, restore the control signal, or send another control signal, to the brake control module 116 when a time elapsed from receiving override signal exceeds a predetermined or timeout value (e.g., 5 sec, 10, sec, 20 sec, etc.). In this manner, if too much time passes from the time when the operator activates the interlock system 216, a time in which surrounding conditions may change (e.g., targets become at risk), the safety afforded by the safety system 210 may be reestablished.

In some embodiments, the controller 214 may generate and provide a report or a notification to at least one operators. The report or notification may be in any form, and include any information. For instance, the controller 214 may generate a report or notification indicating that at least one targets have been identified, and/or are at risk. In one non-limiting example, such report or notification may include imaging, with the target(s) being outlined or highlighted in the imaging. Determined locations of the target(s), or distances to the target(s) may also be included with, or overlayed on, the imaging to indicate where or how far the target(s) is/are from a vehicle 102. The controller 214 may also generate a report or notification indicating that an override signal has been received by the controller 214, or that a control signal has been restored when a time elapsed from receiving the override signal has exceeded a predetermined value.

As shown in FIG. 2, the safety system 210 may include various input/output (I/O) hardware 218. In some embodiments, the I/O hardware 218 may include various input and output elements. Example input elements are buttons, microphones, dials, knobs, touchscreens, keyboards, and so forth. Example output elements are monitors, screens, panels, displays, buzzers, speakers, lights, and so forth. In some embodiments, the I/O hardware 218 may include at least one display device(s) 228, as shown in FIG. 2. The display device(s) 228 may provide imaging (e.g., images, video, and so forth) to an operator local to, or remote from, the vehicle 102. In some embodiments, the display device(s) 228 may be disposed on the interior of the vehicle 102. In some embodiments, the display device(s) 228 may include at least one monitors or screens to display imaging of an area being monitored by the monitoring system 212, as discussed in more detail herein. In some embodiments, imaging may be acquired and displayed live or in real time. In other embodiments, the display device(s) 228 may display images assembled using imaging and/or sensor data acquired by the monitoring system 212. In some embodiments, the display device(s) 228 may provide a combination of live or real time imaging and images assembled using imaging and/or sensor data. In some embodiments, the display device(s) 228 may, in addition to or in lieu of displaying live and/or assembled images and/or video, may display various text, icons, symbols, and the like, as discussed in more detail herein.

In some implementations, the I/O hardware 218 may optionally include at least one communication devices 230 that may be used for wired and/or wireless communication. For example, the communication device(s) 230 may receive data and/or information from at least one modules of the safety system 210 and transmit the data and/or information to an operator remote from the vehicle 102 using a modem, a Bluetooth™ device, a radio device, a cable, a wire, an optical fiber, and so forth. In some embodiments, an operator local to the vehicle 102, or remote from, the vehicle 102 may use the I/O hardware 218 to select various parameter, setting, or modes of operation of the safety system 210. In some embodiments, an operator local to, or remote from, the vehicle 102 may use the I/O hardware 218 to monitor activities or functions of the safety system 210. In other embodiments, an operator remote from the vehicle 102 may use the I/O hardware 218 to communicate with an operator local to the vehicle 102, such as the driver of vehicle 102. Similarly, an operator local to the vehicle 102 may use the I/O hardware 218 to communicate with an operator remote from the vehicle 102.

As shown in FIG. 2, the safety system 210 may optionally include an internal storage 220 module. In some embodiments, the internal storage module 220 may include a memory or a non-transitory computer-readable storage medium that stores and retrieves data, information, and executable instructions. In some embodiments, executable instructions may include, at least in part, instructions for the controller 214 to operate, monitor, and communicate with the modules of the safety system 210, as discussed herein. The internal storage module 220 may also store imaging acquired by the imaging module 224a, 224b, 224c, 224d, 224e, 224f, 224g, 224h, 224l, 224j, 224k, 224l and 224m, as well as corresponding information derived therefrom (e.g., locations or distances to target(s) identified, dates, times, and so forth). In some embodiments, the internal storage module 220 may only store certain data and information for a specific period of time. For example, imaging and corresponding information may be erased from the internal storage module 220 after a day, a week, or a month. In other embodiments, imaging, corresponding information, and any other data and information, stored in the internal storage module 220 may be transmitted by the controller 214 to a remote storage location (e.g., a cloud server) before being erased from the internal storage module 220.

Optionally, the safety system 210 may also include a power module 222 that provides power to the various components of the safety system 210. In some embodiments, the power module 222 may include an internal source of power, such as a battery or other built-in power unit. Additionally, or alternatively, the power module 222 may include hardware and equipment for accessing, utilizing, converting, or managing power supplied by a vehicle 102, as described with reference to FIG. 1.

In some situations, an operator may need to prevent the safety system 210 from engaging a brake system on a vehicle 102. For instance, a driver may be faced with an emergency situation, like a burglar, terrorist, heist, threat to the vehicle 102 or occupants therein, and so forth. Hence, in some embodiments, the safety system 210 may include the capability for disabling the safety system 210. For example, the power module 222, as well as other modules on the safety system 210, may include an emergency switch or button, which may cut power or otherwise prevent the controller 214 from providing a control signal, as described herein. Loss of power, or activation of an emergency switch or button in case of emergency may also trigger audible and/or visible alarms, as well as inform a remote location of the emergency. Hence, disabling the safety system 210 may provide a defense against a bad actor that may be trying to forcibly enter a bus, for example, by allowing a driver to drive away while alerting authorities or calling for help.

Turning now to FIG. 3A, an example vehicle 302 is illustrated monitoring a monitored area 304 exterior to the vehicle 302 using a safety system 310, as described with reference to FIG. 2, for instance. Inside the monitored area 304 is a risk region 306 that defines a region in which at least one targets, if identified therein, may be at risk. The size of the risk region 306 may vary, as discussed in more detail herein. In some embodiments, the risk region 306 may be defined by a number of zones. For instance, FIG. 3A shows the risk region 306 being divided into a Zone A, Zone B, Zone C, Zone D, Zone E, and Zone F. While this example depicts six zones, the number of zones and respective size is not limited.

To monitor the monitored area 304 in FIG. 3A, the vehicle 302 may include a number of imaging module 324a, 324b, 324c, 324d, 324e, and 324f disposed on the vehicle 302, as shown. Also disposed on the vehicle 302 may be a number of an override modules 326a, 326b, 326c, 326d, 326e, and 326f. In this example, each of the imaging module 324a, 324b, 324c, 324d, 324e, and 324f is positioned adjacent a corresponding override module 326a, 326b, 326c, 326d, 326e, and 326f, respectively. Moreover, each imaging module 324a, 324b, 324c, 324d, 324e, and 324f and corresponding override module 326a, 326b, 326c, 326d, 326e, and 326f are disposed on the vehicle 302 at a location that corresponds to a particular zone. For example, Zone F may be monitored by imaging module 324f.

The number and locations of imaging module 324 and/or override modules 326, however, may vary. For instance, in some embodiments, the vehicle 302 may only include one override module 326, located, for instance, at the rear of the vehicle 302. Also, in some embodiments, a zone may be monitored by multiple imaging module 324. For example, Zone A may be monitored by imaging module 324a, 324b, and 324f. In addition, boundaries or the extent of the risk region 306 beyond the vehicle 302 may vary. For instance, as shown in 3B, boundaries of risk region 306 of the vehicle 302 may be defined longitudinally, along a long axis of the vehicle 302, by distances d1 and d2, and laterally, along a short axis of the vehicle 302, by distances d3 and d4. By way of example, distances d1, d2, d3, and d4 may range between 0.1 and 5 m, although other values may be possible. Distances d1, d2, d3, and d4 may have the same or different values, or a combination thereof. For example, distance d1 may be 1 m, distance d2 may be 2 m, distance d3 may be 1 m, and distance d4 may be 1 m.

In some embodiments, values for d1, d2, d3, and d4 may be selected or modified based on a number of conditions or parameter, including a size of the vehicle 302, a location of the vehicle 302, a size of target(s) identified, a movement or speed of the vehicle 302, weather, season, and so forth. For instance, as illustrated in FIG. 3C, when the vehicle 302 moves forward, a front boundary 330 of a modified risk region 306* may extend a distance d1* from the vehicle 302. As shown, d1* may be larger than distance d1, which corresponds to a risk region 306 defined when the vehicle 302 is stationary. Similarly, as illustrated in FIG. 3D, a rear boundary 332 of a modified risk region 306* may extend a distance d2*, which may be larger than distance d2 corresponding to a risk region 306 defined when the vehicle 302 is stationary. In some non-limiting examples, distances d1* and d2* may be 3 m, while distance d1 and d2 may be 1 m. Of course, distances d1, d2, d1*, and d2* may have any values. In addition, since the vehicle 302 may move in any number of directions, the shape and boundaries of the modified risk region 306* may vary.

A safety system 110, 210, as described with reference to FIGS. 1 and 2 may identify at least one targets, and provide a control signal to control a brake system on a vehicle 102, 302 when target(s) are determined to be at risk or pose a risk. However, in certain situations, risk related to target(s) identified may be erroneous or limited in time. For instance, as illustrated in the example of FIG. 3E, pedestrians 340 moving along a path 342 that briefly crosses the risk region 306 may be imaged by an imaging module 324d of a safety system 310. Detecting the presence of pedestrians 340 in the risk region 306, the safety system 310 may then respond and engage the brake system of the vehicle 302 to prevent the vehicle 302 from movement, as described herein. When pedestrians 340 are no longer in the risk region 306, the safety system 310 may then disengage the brake system.

In some scenarios, an operator 344 (i.e. a driver) of the vehicle 302 may determine that pedestrians 340 are erroneously identified to be in the risk region 306, are not at, or do not pose a risk. The operator 344 may then override the safety system 310. For instance, in some embodiments, the operator 344 may engage with or provide input to an override module 326d, which is positioned adjacent the imaging module 324d that imaged the pedestrians 340. To engage with the override module 326d, the operator 344 may exit the vehicle 302, as illustrated in FIG. 3E, which allows for the operator 344 to evaluate risks or ensure no further risks are present. In some embodiments, the operator 344 may provide input to, or engage with, the override module 326 by, for example, by pressing at least one buttons, inputting a passcode, scanning a thumbprint, presenting a card or badge 346, and so forth, or be identified using a monitoring system 212, as described with reference to FIG. 2. In some embodiments, the operator 344 may provide input or engage with more than one of the override modules 326a, 326b, 326c, 326d, 326e, and 326f to ensure that the vehicle 302 and/or targets are completely clear of risk.

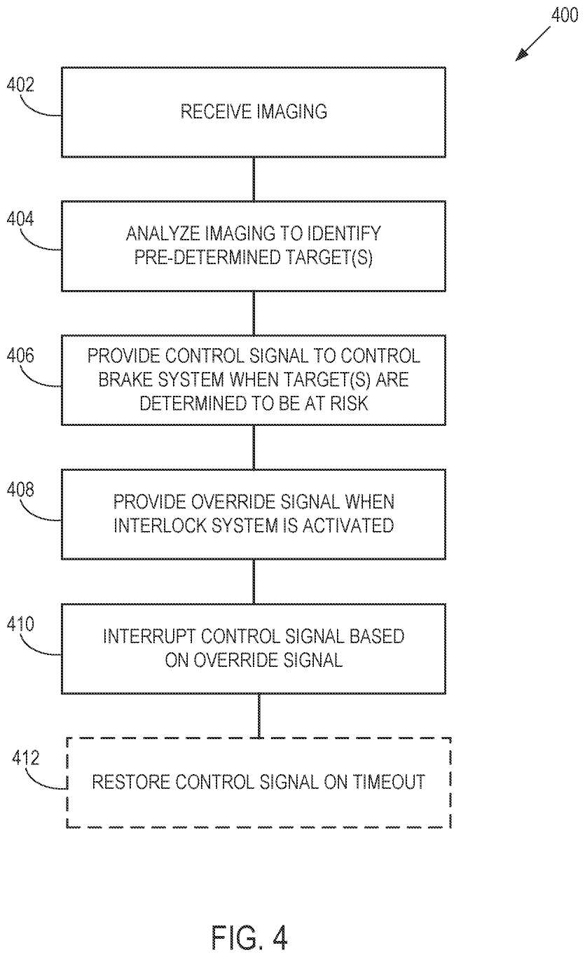

Turning now to FIG. 4 a flowchart setting forth steps of a process 400, in accordance with aspects of the present disclosure, is illustrated. Steps of the process 400 may be carried out using any combination of suitable devices or systems, as well as using systems described in the present disclosure. In some embodiments, some or all of the steps of the process 400 may be implemented as instructions stored in non-transitory computer readable media, as a program, firmware or software, and executed by a general-purpose, programmed or programmable computer, processer or other computing device. In other embodiments, steps of the process 400 may be hardwired in an application-specific computer, processor, or dedicated system or module as described with reference to FIGS. 1 and 2. Although the process 400 is illustrated and described as a sequence of steps, it is contemplated that the steps may be performed in any order or combination, and need not include all of the steps illustrated in FIG. 4.

The process 400 may begin at process block 402 with receiving imaging (e.g., images, video, etc.) of an area exterior to a vehicle 102, 302. In one non-limiting example, imaging received at process block 402 may be acquired using a safety system 110, 210 disposed on a vehicle 102, as described with reference to FIGS. 1 and 2. In some implementations, process block 402 may include acquiring various imaging data and/or sensor data, either continuously or intermittently, and assembling at least one images and/or video using the imaging data and/or sensor data. Additional data and information may also be acquired at process block 402, like camera information, modular sensor information, or other device information.

In some implementations, process block 402 may include selecting a parameter or a setting on at least one cameras, like flash, lens(es) used, shutter speed, capture or readout rate, focus, magnification, aperture, ISO, and so forth, as well as selecting parameter or setting on at least one module sensors, like wavelength, waveform amplitude or intensity, point density, pulse model, coherent detection, capture or readout rate, and so forth. Process block 402 may also include steps for providing guidance or instructions for installing, configuring and operating at least one devices, like imaging module 224a, 224b, 224c, 224d, 224e, 224f, 224g, 224h, 224l, 224j, 224k, 224l and 224m described with reference to FIG. 2, for instance.

Imaging received at process block 402 may then be analyzed to identify at least one targets, as indicated by process block 404. In one non-limiting example, a controller 214, as described with reference to FIG. 2, may be used to analyze the imaging received. As described, analysis may include identifying various persons, animals, objects and so forth, present in the area around or exterior to a vehicle 102, 302. To do so, various computer vision or machine learning algorithms trained to detect target(s) may be utilized. For instance, in one non-limiting example, face recognition software may be used to detect faces of persons appearing in imaging. In another non-limiting example, a machine learning model that is trained to detect persons appearing in imaging may be used. Imaging, as well as other data and information, analyzed at process block 404 may be stored and analyzed locally (e.g., using the safety system 210), or transmitted to a remote location for analysis.

A control signal may then be provided at process block 406 to control a brake system of a vehicle 102. In one non-limiting example, the control signal may be generated by a controller 214, as described with reference to FIG. 2, and provided to a brake control module 114 that controls a brake system on a vehicle 102, as described with reference to FIG. 1. In some implementations, the control signal may be provided when a number of targets identified are determined to be at risk, as indicated by process block 406. Alternatively, the control signal may be provided when target(s) identified in imaging are determined to represent a risk to a vehicle 102. To determine risk, a location of each target identified, and/or a distance between each target identified and a vehicle 102 may be determined at process block 408. As described, the location(s) and/or distance(s) may be determined by analyzing imaging and/or sensor data.

Using location of and/or distance to the target(s) identified, a determination may be made at process block 406 as to whether the target(s) is/are, or will be, inside a risk region around the vehicle 102. In some implementations, a probability of risk to the target(s) and/or vehicle 102 may also be computed at process block 406. As described, in computing the probability of risk, various information may be used, like size and/or type of target(s), speed and/or trajectory of target(s) and/or vehicle 102, estimated duration of target(s) inside the risk region, and so forth. In this manner, persons, animals, objects, and vehicles determined to be at risk may be protected at process block 406 by allowing for automatic engagement of a brake system, thereby preventing vehicle 102 movement, and hence injury or accident.

An override signal may then be provided at process block 408. In one non-limiting example, an override signal may be generated when an interlock system 216, as described with reference to FIG. 2, is activated by an operator. As described, an operator may initiate the generation of an override signal by providing input into an override module 226a, 226b, 226c, 226d, 226e, 226f, 226g, 226h, 226i, 226j, 226k, 226l and 226m of the interlock system 216, for instance. In some implementations, such activation may require the operator to satisfy certain security requirements, like scanning a card, inputting a password, scanning a thumbprint, stepping in front of a camera to be imaged, and so forth. The override system 216 may then transmit the override signal to a controller 214, for instance. Once the override signal is received, the control signal provided to control the brake system on a vehicle 102 may then be interrupted, or modified, to disengage the brake system, as indicated by process block 410. In some implementations, another control signal may be sent to disengage the brake system. In either case, the interlock system 216 allows for an operator to manually override the automatic engagement of the brake system once he or she determines that there is no more risk by physically checking the location that triggered the brake engagement.

Optionally, a control signal controlling the brake system on the vehicle 102 may be restored on a timeout, as indicated by process block 412. For instance, a controller 214, in response to receiving the override signal from the interlock system 216 and interrupting or modifying the control signal to the brake control module 116, may restore or send another control signal to the brake control module 116 when a time elapsed from receiving the override signal exceeds a predetermined or timeout value (e.g., 5 sec, 10, sec, 20 sec, etc.). Hence, if a driver, for example, becomes distracted or takes too long in returning to the vehicle 102 after the override, the brake system may be once again engaged automatically to ensure safety.

In some implementations, a report or notification may be generated and provided to at least one operators at various points in process 400. The report or notification may be generated and provided intermittently or continuously in substantially real-time. For instance, the operator(s) may be notified when at least one targets are identified, and/or when the target(s), or vehicle 102, is determined to be at risk. The report or notification may be in any form, and provide various information. For instance, the report or notification may include visual and/or audio signals, images, tabulated information and data, instructions, icons, texts, symbols, colors, and combinations thereof. The report or notification may be communicated or displayed, for example, using the I/O hardware 218 described herein. In some implementations, the report or notification, or portions thereof, may be stored, for example, in an internal storage 220, or transmitted to a remote storage location (e.g., a cloud server). In one non-limiting example, a report or notification may include images depicting an exterior of a vehicle 102, 302, a time stamp, a date stamp, information about the vehicle 102, 302, like location, speed, heading, and so forth. A report or notification may also include imaging in which identified target(s) are outlined or highlighted, along with respective locations of, or distances to, target(s). A report or notification may further include an indication of whether target(s) identified in imaging or vehicle 102, 302 are at risk, or probability of risk.

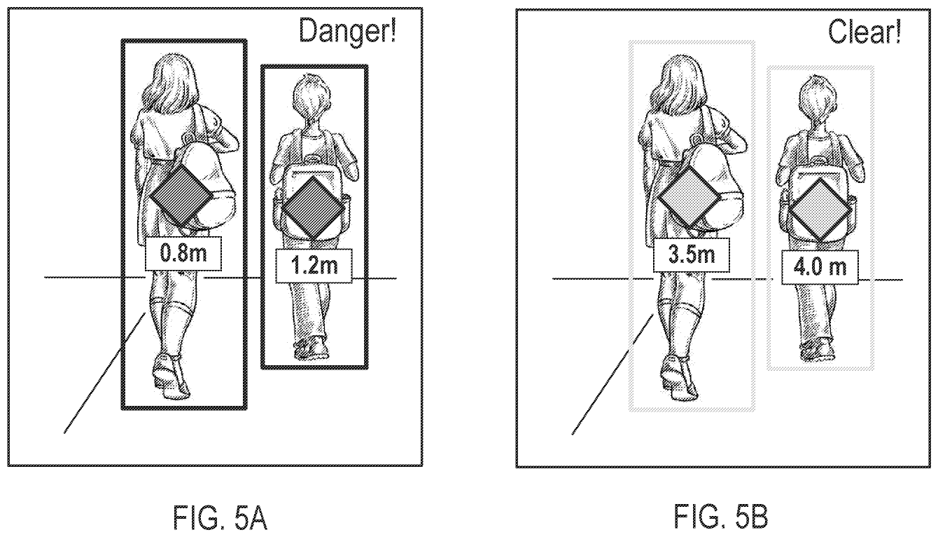

FIGS. 5A and 5B show non-limiting examples of reports or notifications that may be provided to an operator. In some implementations, reports or notifications may be provided via a display device(s) 228, as described with reference to FIG. 2. Referring specifically to FIG. 5A, an image of two young pedestrians is shown, where each young pedestrian identified in the image is highlighted with a colored box (i.e., red box) overlayed on the image. Each (red) colored box includes a colored (i.e., red), filled-in symbol (i.e., diamond symbol), along with text indicating a distance to the respective pedestrian, namely “1.2 m” and “0.8 m”. FIG. 5A also includes the text “Danger!” overlayed on the image. In this example, the color (red) and text may be used to indicate that the young pedestrians are at risk. Similarly, FIG. 5B shows an image of two young pedestrians highlighted with another colored box (i.e., green box). Each (green) colored box includes a colored (i.e., green), outlined symbol (i.e., diamond symbol), along with text indicating a distance to each pedestrian, namely “4.0 m” and “3.5 m,” respectively. FIG. 5B also includes the text “Clear!” overlayed on the image. In this example, the color (green) and text are used to indicate that the young pedestrians are not, or no longer at risk (e.g., outside of a risk region). While FIGS. 5A and 5B utilize certain colors, text, symbols, and shapes to highlight pedestrians and indicate their risk, it may be appreciated that any colors, text, symbols, and shapes may be used.

According to one embodiment, a safety system for a vehicle is provided. The system comprises a monitoring system comprising at least one imaging module 224a, 224b, 224c, 224d, 224e, 224f, 224g, 224h, 224l, 224j, 224k, 224l and 224m disposed on the vehicle to acquire imaging of an area exterior of the vehicle. The system also comprises a controller 214 operatively connected to the monitoring system and to a brake control module that operates a brake system on the vehicle, wherein the controller 214 analyzes imaging received from the monitoring system to identify at least one targets in the area exterior of the vehicle, and provides a control signal to the brake control module when the at least one targets are determined to be at risk. The system further comprises an interlock system 216 operatively connected to the controller. The interlock system 216 includes at least one override module and provides an override signal to the controller 214 when activated by an operator. In one embodiment the at least one imaging module 224a, 224b, 224c, 224d, 224e, 224f, 224g, 224h, 224i, 224j, 224k, 224l and 224m comprise at least one of a camera, a module sensor, or a combination thereof. In one embodiment, the interlock system comprises at least one of a switch, a near-field communication tag, a RFID tag, a button, a badge, a touchscreen, or a combination thereof. In one embodiment, the interlock system comprises at least one override modules 226a, 226b, 226c, 226d, 226e, 226f, 226g, 226h, 226i, 226j, 226k, 226l and 226m that generate the override signal when activated by the operator, wherein at least one of the at least one override modules 226a, 226b, 226c, 226d, 226e, 226f, 226g, 226h, 226i, 226j, 226k, 2261 and 226m is positioned adjacent at least one of the at least one imaging module 224a, 224b, 224c, 224d, 224e, 224f, 224g, 224h, 224l, 224j, 224k, 224l and 224m. In one embodiment, the controller 214 analyzes the imaging using a computer vision algorithm or a machine learning algorithm that is trained to identify the at least one targets. In one embodiment, the controller 214 analyzes the imaging to determine a distance between the at least one targets and the vehicle. In one embodiment, the controller 214 determines, using the distance, whether the at least one targets are inside a risk region and generates the control signal based on the determination. In one embodiment, the controller 214 interrupts the control signal to the brake control module when the controller 214 receives the override signal from the interlock system or when the controller 214 determines that the at least one targets are no longer at risk. In one embodiment, the controller restores the control signal to the brake control module when a time elapsed from receiving the override signal exceeds predetermined value.

According to another embodiment, a method for controlling a brake system on a vehicle using a safety system is provided. The method comprises receiving imaging of an area exterior to a vehicle acquired using a monitoring system, and using a controller disposed on the vehicle, analyzing imaging acquired by the monitoring system to identify at least one targets in the area exterior to the vehicle. The method also comprises providing, using the controller, a control signal to a brake control module to control a brake system on the vehicle when the at least one target is determined to be at risk, and providing an override signal to the controller 214 when an interlock system on the vehicle is activated by an operator. The method further comprises, interrupting the control signal when the controller 214 receives the override signal from the interlock system. In one embodiment, the method comprises analyzing the imaging using a computer vision algorithm or a machine learning algorithm that is trained to identify the at least one targets. In one embodiment, the method comprises determining a distance between the at least one target and the vehicle, and, using the distance, determining whether the at least one target is inside a risk region around the vehicle. In one embodiment, the method comprises providing the control signal when the at least one targets is inside the risk region, and notifying the operator that the at least one targets is determined to be at risk. In one embodiment, the method comprises interrupting the control signal when the controller 214 determines that the at least one target is no longer at risk. In one embodiment, the method comprises restoring the control signal when a time elapsed from receiving the override signal exceeds predetermined value.

What is claimed is:

1. A safety system for a vehicle, the safety system comprising:
a monitoring system comprising at least one imaging module disposed on the vehicle to acquire imaging of an area exterior of the vehicle;
a controller operatively connected to the monitoring system and to a brake control module disposed n the vehicle that operates a brake system on the vehicle, wherein the controller analyzes imaging received from the monitoring system to identify at least one target in the area exterior of the vehicle, and to provide a control signal to the brake control module when the at least one target is determined to be at risk; and
an interlock system operatively connected to the controller;
the interlock system comprising at least one override module providing an override signal to the controller when an operator activates the at least one override module.

2. The safety system of claim 1, wherein the at least one imaging module comprise at least one of a digital single-lens reflex camera, a mirrorless camera, a bridge camera, a panoramic camera, a 360 degree camera, a twin-lens reflex camera, a module sensor, a light detection and ranging sensor, a radar sensor, a proximity sensor, an audio sensor and an audio receiver.

3. The safety system of claim 2, wherein the interlock system comprises at least one of a switch, a near-field communication tag, a radio frequency identification tag, a button, a badge and a touchscreen.

4. The system of claim 3, wherein the interlock system comprises at least one override module that generates the override signal when the at least one override module is activated by the operator.

5. The safety system of claim 1, wherein the controller analyzes the imaging using at least one of a computer vision algorithm and a machine learning algorithm that is trained to identify the at least one target.

6. The safety system of claim 5, wherein the controller analyzes the imaging to determine a distance between the at least one target and the vehicle.

7. The safety system of claim 6, wherein the controller determines, using the distance, whether the at least one target is inside a risk region and generates the control signal based on determination of the at least one target being inside the risk region.

8. The safety system of claim 1, wherein the controller interrupts the control signal to the brake control module when the controller at least one of receives the override signal from the interlock system and the controller determines that the at least one target is no longer at risk.

9. The safety system of claim 8, wherein the controller restores the control signal to the brake control module when a time elapsed from receiving the override signal exceeds a predetermined value.

10. The safety system of claim 1 wherein the at least one override module is located adjacent the at least one imaging module.
